(19) United States
(12) Patent Application Publication
(10) Pub. No.: US 2003/0223243 A1
(43) Pub. Date: Dec. 4, 2003

(54) Illuminating automobile wheel device

(76) Inventor: Archie F. Miller, Memphis, TN (US)

Correspondence Address: US CORPORATIONS, INC., 630 NEPTUNE AVE., ENCINITAS, CA, 92024, US

(21) Appl. No.: 10/411,863

(22) Filed: Apr. 11, 2003

Related U.S. Application Data
(60) Provisional application No. 60/372,302, filed on Apr. 12, 2002.

(51) Int. Cl. B60Q 1/00

(52) U.S. Cl. 362/487; 362/500

(57) ABSTRACT

An universal illuminating automobile wheel device light system capable of transmitting consistent electric current at high surface speeds to 2 conductive rings which are rotatable in current, comprising of a rotating body containing brush blocks including silver alloy contacts, adjustable aluminum brush mounting brackets, monolithic made slip rings with flexible circuit board and LED lighting, allowing the device to fit and work on nearly every wheel made.

### CROSS-REFERENCE TO RELATED APPLICATION

This application relies on a previously filed provisional application 60372302 filed on Apr. 12, 2002.

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

This invention concerns a light system for illuminating a wheel on a vehicle, particularly automobiles

2. Description of the Prior Art

Various modifications has been made using reflectors, lighted reflectors, and lights. For example, U.S. Pat. No. 5,278,732 provides illuminated reflectors mounted on the spoked wheel of a bicycle. U.S. Pat. No. 4,800,469 discloses a self contained light with power source for mounting on the valve stem of a tire. U.S. Pat. No. 4,796,972 describes a rotary electrical contact assembly mounted on a bicycle wheel to power a lighted reflector mounted on a bicycle wheel. U.S. Pat. No. 4,787,014 discloses a self contained light source mounted on the spokes of a bicycle.

The current invention is an automobile illuminating wheel device with conductive brushes capable of transmitting consistent electric current at high surface speeds to 2 conductive rings which are rotatable in current allowing the device to fit and work on nearly every wheel made.

### SUMMARY OF THE INVENTION

The ascetic appearance of a vehicle and its wheels are an important factor. The manufacturers of automobiles are constantly striving to improve the appearance of the automobiles they produce and have entire departments that constantly work on the ascetic appearance of their automobiles.

Improving the appearance of the wheels of the automobile from conventional stamped rims includes the use of wheel covers or hubcaps which have been provided in various designs and geometric configurations that are decorative and aesthetically appealing. In addition, the wheel rims themselves have been changed in design from the basic stamped rim to “mag” wheel rims of a number of different designs. These mag wheel rim and wheel cover designs have constantly attempted to provide a distinctive appearance on the vehicle which is ascetically pleasing.

The automobile has been around since a little after the turn of the 20^{th} century, and of course the automobile wheel was a functional part of it, but that is all the automobile wheel was at that time functional. Design was based purely on load capacity and endurance. The first wheels were primarily made for horse drawn coaches and wagons, after all the first automobiles were merely coaches with gasoline powered engines, but as the market developed comfort and style became an important part of owning a motor driven vehicle. Automobile accessories were constantly being invented and marketed successfully, and the automobile aftermarket began to grow by leaps, and bounds. This was due to one fact primarily, and that was that automobile owners wanted their vehicle to exude individualism. They wanted their own personal identity. This included their wheels now the race was on, from spokes to solid wheels, and then to stylish hubcaps. Little did anyone realize what the evolution of the automobile wheel would do.

In the 1960's the wheel was primarily a solid steel wheel dressed with a hub cap to blend with the make of the automobile, but something more was desired to differentiate the owner's taste, especially the younger motorist. Attention was key, in that recognition of the individual, and how they perceived themselves was paramount, therefore the hubcap took on a whole new perspective, from spinners to moon's, and wheel rings with center hubs. Then in the late 60's a leap was made away from the hubcap to chrome plated wheels, and then to chrome plated spoke wheels.

Fiber optic technology recognizes that light may be conducted through an optically transmitting material such as plastic and glass. The light preferably enters the optically transmitting plastic through one end and is transmitted through the plastic away from that end. The sides of the plastic are polished so that as light travels through the plastic, the light reflects off of the sides as it moved down the plastic to the other end. It is desirable to contain the light in the plastic until it reaches a light emitting portion. The light emitting portion of the optically transmitting material is preferably not polished so that the light passes through it and is visible to the observer.

In the 90's the custom wheel was seen on many more vehicles, and by 1999, it became apparent that this was the wave of the future. Since 1999 the custom wheel has more shapes and designs than imaginable, from all types of spoke designs to wheels that continue to spin after the vehicle stops. Design is king, and the more unique the better, remember the automobile has become the extension of the owner's identity. With the realization of the proceeding history, it is now time for the wheel to be lighted. After all we must remember, the reason for purchasing fancy wheels is because one wants to show them off. This is impossible to do adequately at night, unless you have a lighted wheel. Thus the invention of a kit that can be installed on the majority of wheel styles, and automobile hubs, yes a kit that can allow one to show off their wheels without being limited to a certain wheel. This brought us to the invention of the night wheel.

In the years gone by people have invented and patented a lighted wheel, but the problem was either the type of lighting that was used, or that it was intrusive to the wheel or the automobile, in that the wheel had to be drilled to receive the lights or that the lighting table had to be anchored with screws into the wheel, or attached to a hub ring made of metal that fit between the wheel and the hub, therefore it becomes a spacer. The other problem for most of these patents, is that an entirely different design would need to be developed for most wheels.

The lighted wheel can also be considered to be safer. Just like aircraft identification lights, the lighted wheel makes a vast improvement for being seen at night or in bad weather

The safety of a vehicle is another important factor in the design of an automobile. It is recognized that the safety of a vehicle is improved when the vehicle is visible from the side, particularly in the dark or dimly lit conditions. To improve the visibility of a vehicle from the side, lights have been mounted on the sides of the vehicle body. Accordingly, a vehicle or pedestrian approaching the vehicle from its side can see the vehicle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that any claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by any claims, nor is it intended to be limiting as to the scope of the invention in any way.

These together with other objects of the invention, along with the various features of novelty which characterize the invention, are pointed out with particularity in the future claims annexed to and forming a part of this disclosure. For a better understanding of the invention, its operating advantages and the specific objects attained by its uses, reference should be had to the accompanying drawings.

### BRIEF DESCRIPTION

Illlustrations

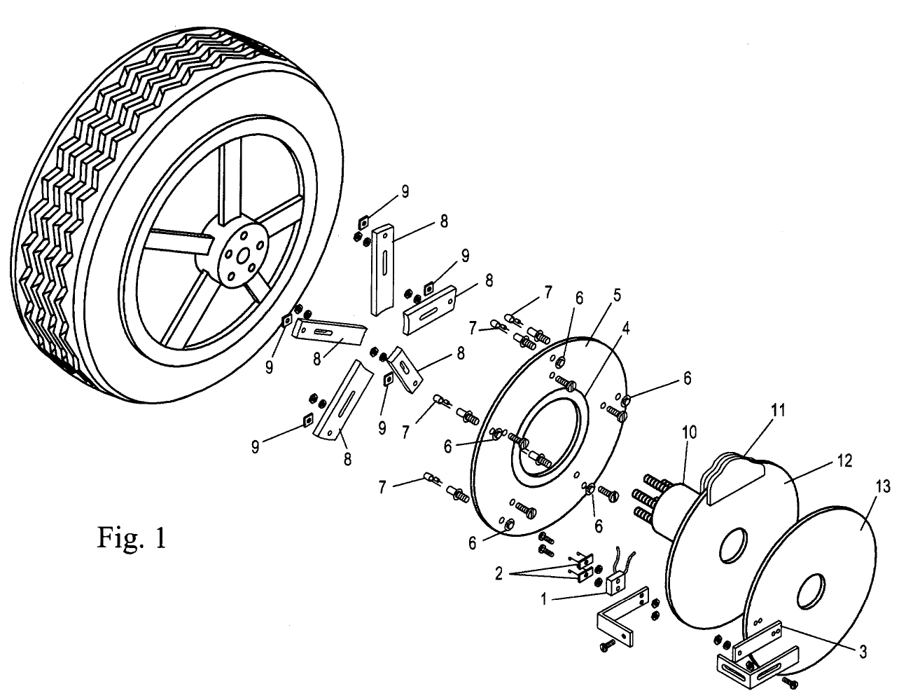

FIG. 1

is a perspective view of the preferred embodiment of the present invention with all components listed. This view depicts the device and components as placed behind the automobile wheel.

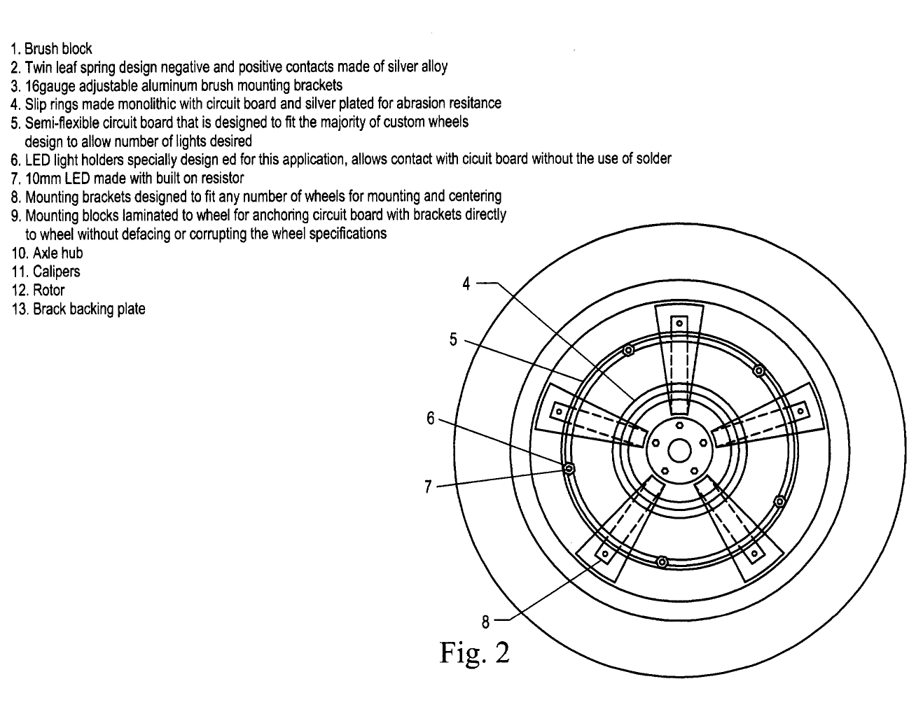

FIG. 2

is a perspective view of the preferred embodiment of the present invention of the exterior side of the automobile wheel and relative placement of the device.

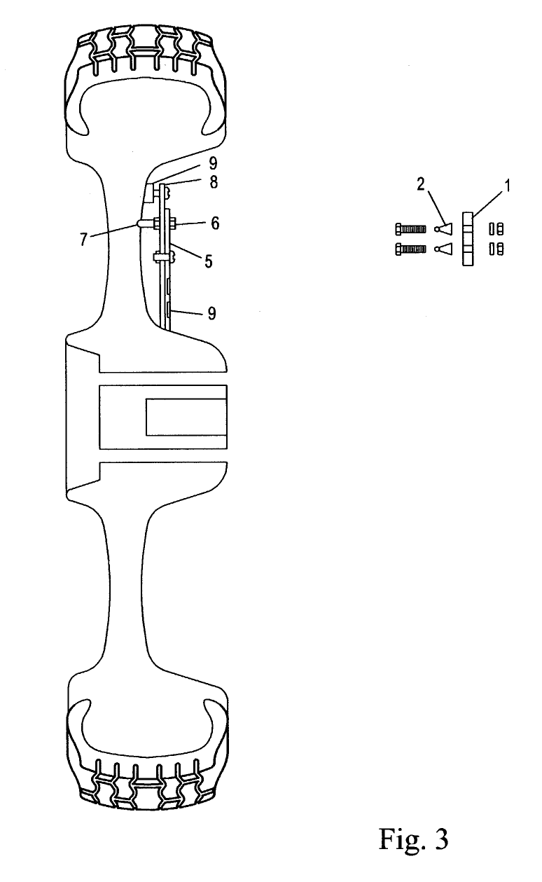

FIG. 3

is a perspective view of the preferred embodiment of the present invention viewing a cross section of a wheel and hub illustrating the location of the present device.

### DETAILED DESCRIPTION OF THE PREFERRED EMBODIMENT

The preferred embodiment of the present invention can be seen in the accompanying drawings.

The brush block 1 holds the ground and positive wires from the vehicle, as well as the four leaf spring mounted contacts 2. These are all mounted to 3, the adjustable aluminum brackets, which are anchored in place to the brake backing plate 13. These are the parts that deliver power from the vehicle, to the slip ring 4, which is monolithic with the semi-flexible circuit board 5. The semi flexible circuit board 5, being monolithic with the slip ring 4, is also connected directly to the power delivered to the slip ring 4, by the leaf spring contacts 2.

Thus, this is the flow of current from the vehicle to the lights 7. First the power is transferred to the brush block 1, into the leaf spring contacts 2, which make contact with the slip rings 4, as they rotate. Then through to the monolithic circuit board 5, which is directly connected to the slip ring. Once the power passes through the circuit board 5, it flows into the lights 7, through the positive leads that are made with the L.E.D.'s 7. These L.E.D.'s are current balance for even balance of lighting, by a resistor that is built onto the leads. The L.E.D. 7, has two leads one is negative and one is positive, thus the positive current flows from the vehicle to the L.E.D.s 7 through the brush block 1 to the contacts 2 to the slip rings 4, into the circuit board 5, and then to the LED lights 7. In just the opposite The LED 7 sends ground or negative flow of energy, back through the negative side of the circuit board 5, through the negative slip ring 4, back into the negative contacts 2, and the negative side of the brush block 1, to return to the vehicle main ground, as shown in FIG. 1.

FIG. 3 shows the mounting of the monolithic slip ring 4, and circuit board 5. The mounting brackets 8, are adjusted for center off either the hub of the rim, by use of a slotted hole in the bracket, and then tightened in position, to the monolithic circuit board 5, and slip ring 4. Once this is accomplished, the mounting blocks 9, are positioned and laminated to the vehicle rim, and then the circuit board mounting brackets 8, are anchored by screws to the mounting blocks 9.

This system works universally with almost every wheel imaginable, due to the inside diameter of the monolithic circuit board 5, slip ring 6, and the semi-flexibility of the same, as well as the uniqueness of the mounting system which allows for all types of variations in depth and height.

We claim:

1. What is claimed as being new and desired to be protected is as follows:
A illuminating automobile wheel device comprising:
a rotating body composed of brush blocks including silver alloy contacts, adjustable aluminum brush mounting brackets, monolithic made slip rings with circuit board and silver plated for abrasion resistance while the said circuit board is semi-flexible to contact solder-free led light holders which maintain 10 mm led with built in resistor and universal mounting brackets laminated for mounting said circuit board;
conductive brush device constructed of long lasting alloy material, capable of transmitting consistent electric current at high surface speeds.

2. An illuminating automobile wheel device according to claim 1 wherein the use of two stationary brushes for the transfer of positive and negative current made with a backup brush.

3. An illuminating automobile wheel device according to claim 1 wherein conductive brushes provide electrical circuit which originates with the vehicle's power source and terminates with the vehicle's power source ground.

4. An illuminating automobile wheel device according to claim 1, wherein grounding to the vehicles main ground, device provides consistent, uninterrupted flow of current to the conductive brushes, and substantially mitigates the possibility of short-circuiting

5. An illuminating automobile wheel device according to claim 1, wherein the stationary brush design incorporates the use of leaf springs.

6. An illuminating automobile wheel device according to claim 1, wherein a single device incorporating two conductive rings that are rotateable in current.

7. An illuminating automobile wheel device according to claim 1, wherein a rotateable conductive ring can be of two different designs to accommodate drum or disc brakes determined by the space inside the wheel.

8. An illuminating automobile wheel device according to claim 1 wherein conductive rings are constructed of long lasting alloy material capable of continuous, uninterrupted flow of current at high revolutions or at high speed of conductive rings rubbing against brush.

9. An illuminating automobile wheel device according to claim 1 wherein alloy construction of conductive rings reduce the possibility of moisture absorption thereby reducing any possibility of short circuit.

10. An illuminating automobile wheel device according to claim 1 wherein alloy construction of conductive rings retards surface wear at high speeds.

11. An illuminating automobile wheel device according to claim 1 wherein a conductive ring is designed with special brackets for anchoring in two directions.

12. An illuminating automobile wheel device according to claim 1 wherein the device incorporates printed circuit design in lieu of wiring harness for transferring power from the brushes to the lights

13. An illuminating automobile wheel device according to claim 1 wherein the design allows solid state electronics to be used, which affords stability and balance of current to virtually any number of lights.

14. An illuminating automobile wheel device according to claim 1 wherein the device design enables power to be furnished to all lights consistently even if one light is inoperable or is missing altogether.

15. An illuminating automobile wheel device according to claim 1 wherein custom light holders are made of highly durable polymers allowing for variation in wheel depth, and configuration including quick and easy changing of lights if damaged.
